(19) United States
(12) Patent Application Publication
(10) Pub. No.: US 2004/0105734 A1
(43) Pub. Date: Jun. 3, 2004

(54) Anchoring system and methods therefor

(76) Inventors: David Yekutiely, Ramat HaSharon (IL); Barak Yekutiely, Teaneck, NJ (US)

Correspondence Address: Dekel Patent Ltd., Beit HaRof'im, 18 Menuha VeNahala Street, Room 27, Rehovot, IL

(21) Appl. No.: 10/615,176

(22) Filed: Jul. 9, 2003

Related U.S. Application Data
(62) Division of application No. 09/884,904, filed on Jun. 21, 2001, now abandoned.

(51) Int. Cl. F16B 13/06; B23B 35/00

(52) U.S. Cl. 411/55; 408/1 R

(57) ABSTRACT

An anchoring system including an anchor including a shank with an expandable portion and a wedge arranged to wedge against the expandable portion, the expandable portion having a first portion thicker than a second portion thereof. There is also disclosed an anchoring system including an anchor including a shank with an expandable portion and a wedge arranged to wedge against the expandable portion, and a biasing device adapted to exert an outwardly directed expanding force against the expandable portion.

### FIELD OF THE INVENTION

The present invention relates generally to fixing systems, and particularly to anchoring systems for attaching objects to surfaces, walls, ceilings and the like.

### BACKGROUND OF THE INVENTION

Anchors are well known mechanical fasteners used to attach objects to walls or ceilings of various building materials, including, but not limited to, concrete, masonry, brick, chipboard, gypsum, wood, pumice, expanded clay, or aerated concrete (e.g., porous building blocks with a low compressive strength). Anchors may be made of metal or plastic or other suitable engineering materials.

Anchors generally comprise a shank with an expandable portion, either along the length of the shank or towards the tip of the shank. For example, one popular type of anchor includes a conical wedge element at the tip of the anchor. The anchor has a shank with bifurcations formed at the tip, thereby forming a plurality of expandable leaves at the tip of the shank. The wedge may be forced against these leaves so as to expand them outwards. The wedging action may be accomplished by several methods. For example, the wedge may be attached to a threaded rod that protrudes through the opposite end of the shank, such an anchor being called a bolt anchor or a through anchor. A nut may be fastened on the open end of the threaded rod. Tightening the nut pulls the wedge against the leaves. In another example, called a threaded anchor, a machine screw or bolt goes through the shank body and is threadedly fastened to the wedge. Tightening the screw/bolt pulls the wedge against the leaves. In yet another example, called a hammerset anchor, the wedging action is typically accomplished by hammering the sleeve over the wedge.

Installation of the anchor generally requires drilling a hole in the building material, such as by rotary drilling, impact drilling or hammer drilling. The anchor may then be inserted in the drilled hole and tightened in place. The tightening action expands the expandable portion of the anchor and presses it against the inner diameter of the drilled hole. The pressure of the expanded portion against the inner diameter of the hole provides the required holding force to fasten the object to the wall or ceiling and the like.

However, pressing the expandable portion of the anchor against the inside of a straight hole may be problematic. For example, the pressure may cause cracking of the building material. Moreover, since the amount that the expandable portion can expand is limited, the holding strength of the anchor is likewise limited.

### SUMMARY OF THE INVENTION

The present invention seeks to provide improved anchoring systems with significantly greater fastening integrity, reliability and longevity than prior art anchors. The invention also seeks to provide a “dynamic” anchoring system that compensates for changes or weakening in the anchoring material, such as cracks, fissures or breaks due to aging, vibration, shock or catastrophes, such as earthquakes, and maintains its fastening integrity in the anchoring material.

In a preferred embodiment of the invention, the anchor comprises a two-stage expanding anchor. In the first stage, the anchor may be expanded in a manner similar to prior art anchors, such as in a straight drilled hole. However, unlike the prior art, the anchor has a second stage of expansion, which may be used to great advantage in an undercut hole. The expandable portion of the anchor comprises a thickened wall that may be expanded into the void of an undercut hole. The expandable portion does not meet any resistance while expanding into the cavity of the undercut hole. Once expanded in this cavity, the expanded portion tightly and reliably locks the anchor in place. The undercut hole has a significantly greater area against which the expanded portion presses, and thus the holding strength of the anchor is significantly greater than the prior art. Synergistically, at the same time, there is less stress on the building material because of the greater area over which the anchor exerts pressure. The result is that the anchor of the present invention has significantly greater fastening integrity, reliability and longevity than prior art anchors.

In the prior art, the outwardly directed pressure of the expandable portion of the anchor stems from the resilience of the anchor material, whether plastic, metal or other material. However, the resilience of the material alone cannot compensate for changes in the diameter of the drilled anchoring hole. Such changes may occur over time due to fatigue, vibration or shock, for example. In addition, the resilience of the material may diminish over time, thereby weakening the fixation strength of the anchor. As mentioned above, cracks, fissures or breaks due to aging, vibration, shock or catastrophes, such as earthquakes, may also weaken or otherwise detrimentally affect the strength of the anchor.

The present invention provides solutions to these problems. In a preferred embodiment of the invention, the anchor comprises a biasing device that continuously exerts an outwardly directed expanding force against the expandable portion. The biasing device may comprise any type of spring, such as a coil spring, or an elastomeric material with sufficient spring properties, for example. The biasing device transforms the anchor into a “lock” anchor, in a manner similar to a lock washer used with a threaded fastener. Even if the diameter of the drilled hole increases, such as over time due to vibration, or in the event of an earthquake, for example, the biasing device further expands the expandable portion of the anchor and ensures that the expandable portion securely abuts against the building material.

In another preferred embodiment of the invention, the anchor comprises a power-driven biasing device (e.g., hydraulic, pneumatic, solenoid) that selectively tightens and loosens the anchor into a wall or ceiling and the like. The anchor may have safety/failure indicators to indicate if the anchor is safely anchored in place. If the anchoring strength has changed due to vibration or catastrophe, the pressure exerted by the biasing device may be automatically increased to compensate for the lack of holding strength, and re-establish a safe strength. Such an anchor may be used in a variety of systems, such as a robot that can climb up a wall by drilling holes and alternatively anchoring itself into and releasing itself from the wall.

There is thus provided in accordance with a preferred embodiment of the present invention an anchoring system including an anchor including a shank with an expandable portion and a wedge arranged to wedge against the expandable portion, the expandable portion having a first portion thicker than a second portion thereof.

There is also provided in accordance with a preferred embodiment of the present invention an anchoring system including an anchor including a shank with an expandable portion having a variable-size fulcrum and a wedge arranged to wedge against the variable-size fulcrum of the expandable portion.

In accordance with a preferred embodiment of the present invention the wedge is adapted to expand the expandable portion outwards further when wedged against the first portion than when wedged against the second portion.

Further in accordance with a preferred embodiment of the present invention the expandable portion is generally hollow, and the first portion of the expandable portion has a thicker wall thickness than the second portion.

Still further in accordance with a preferred embodiment of the present invention the expandable portion is formed with a hole therethrough, the hole having a non-uniform diameter along its axial length, wherein a diameter of the hole is smaller at the first portion of the expandable portion than at the second portion of the expandable portion.

Additionally in accordance with a preferred embodiment of the present invention a wedging device is provided that is adapted to wedge the wedge against the expandable portion. The wedging device may include a threaded fastener coupled to the wedge, or a hammerset wedging device adapted to impart relative axial motion between the wedge and the expandable portion, for example.

In accordance with a preferred embodiment of the present invention the shank includes an internally threaded portion adapted for threaded engagement with a male-threaded fastener.

Further in accordance with a preferred embodiment of the present invention an undercut drilling tool is provided that is adapted to drill a hole with an undercut portion adapted for at least one of the first and second portions of the expandable portion to expand therein.

Still further in accordance with a preferred embodiment of the present invention a biasing device is adapted to exert an outwardly directed expanding force against the expandable portion.

In accordance with a preferred embodiment of the present invention the biasing device is adapted to urge the wedge against the expandable portion when the wedge is wedged against the expandable portion.

There is also provided in accordance with a preferred embodiment of the present invention an anchoring system including an anchor including a shank with an expandable portion and a wedge arranged to wedge against the expandable portion, and a biasing device adapted to exert an outwardly directed expanding force against the expandable portion.

### BRIEF DESCRIPTION OF THE DRAWINGS

The present invention will be understood and appreciated more fully from the following detailed description taken in conjunction with the drawings in which:

FIG. 1 is a simplified pictorial illustration of an anchoring system, constructed and operative in accordance with a preferred embodiment of the present invention;

FIG. 2 is a simplified pictorial illustration of the anchoring system of FIG. 1, wherein a wedge starts to expand an expandable portion of an anchor outwards in a cavity of an undercut hole, in accordance with a preferred embodiment of the present invention;

FIG. 3 is a simplified pictorial illustration of the anchoring system of FIG. 1, wherein the wedge has completely expanded the expandable portion of the anchor against the inner surface of the undercut hole, in accordance with a preferred embodiment of the present invention;

FIGS. 4A-4D are simplified illustrations of the installation of the anchor and the use of anchoring system, in accordance with a preferred embodiment of the present invention;

FIG. 5 is a simplified pictorial illustration of the anchoring system of FIG. 1, wherein the anchoring system includes a bolt or threaded anchor;

FIG. 6 is a simplified pictorial illustration of the anchoring system of FIG. 1, wherein the anchoring system includes a hammerset anchor;

FIG. 7 is a simplified pictorial illustration of an anchoring system, constructed and operative in accordance with another preferred embodiment of the present invention, and comprising a secondary wedge that wedges into an expandable wedge;

FIGS. 8A and 8B are simplified illustrations of the expansion of the anchoring system of FIG. 7, in accordance with a preferred embodiment of the present invention;

FIG. 9 is a simplified pictorial illustration of an anchoring system, constructed and operative in accordance with another preferred embodiment of the present invention, including a dynamic anchor with a spring-like biasing device;

FIG. 10 is a simplified pictorial illustration of an anchoring system, constructed and operative in accordance with another preferred embodiment of the present invention, including a dynamic anchor with an elastomeric biasing device;

FIG. 11 is a simplified pictorial illustration of the anchor of the anchoring system of FIG. 9 installed in a hole drilled in a wall;

FIG. 12 is a simplified pictorial illustration of the dynamic action of the anchor that maintains a secure fit, in accordance with a preferred embodiment of the present invention;

FIG. 13 is a simplified pictorial illustration of an anchoring system, constructed and operative in accordance with yet another preferred embodiment of the present invention, including a dynamic anchor that includes a power-driven biasing device, comprising a fluid-power biasing device;

FIG. 14 is a simplified pictorial illustration of an anchoring system, constructed and operative in accordance with still another preferred embodiment of the present invention, including a dynamic anchor that includes a power-driven biasing device, comprising an electrical biasing device;

FIGS. 15A, 15B and 15C are simplified pictorial illustrations of a robotic system constructed and operative in accordance with a preferred embodiment of the present invention, which incorporates power-driven biasing devices; and

FIG. 16 is a simplified pictorial illustration of apparatus, constructed and operative in accordance with a preferred embodiment of the present invention.

### DETAILED DESCRIPTION OF A PREFERRED EMBODIMENT

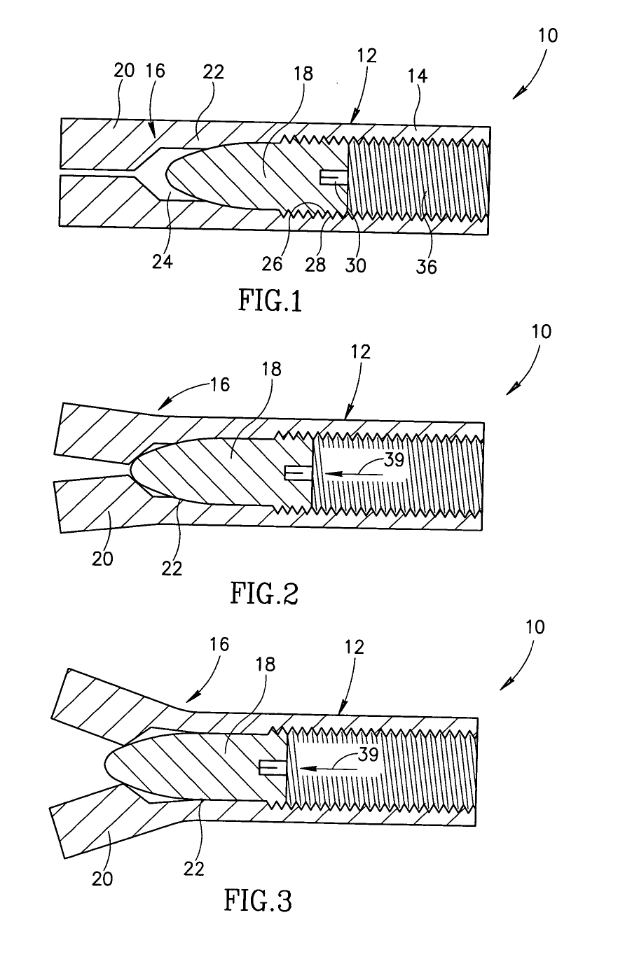

Reference is now made to FIG. 1, which illustrates an anchoring system 10, constructed and operative in accordance with a preferred embodiment of the present invention.

Anchoring system 10 preferably includes an anchor 12 comprising a shank 14 with an expandable portion 16 and a wedge 18 arranged to wedge against expandable portion 16. Expandable portion 16 has a first portion 20 thicker than a second portion 22 thereof. Expandable portion 16 may be at least partially hollow, with first portion 20 having a thicker wall thickness than the second portion 22. This may be accomplished by forming expandable portion 16 with a hole 24, wherein hole 24 has a non-uniform diameter along its axial length. In other words, the diameter of hole 24 is smaller at the first portion 20 than at the second portion 22.

The expandable portion 16 is thus constructed as a variable-size fulcrum for wedge 18 to wedge against. As will be described further in detail hereinbelow, when wedge 18 wedges against the second portion 22, expandable portion 16 expands outwards in a first stage of expansion. When wedge 18 wedges against the first portion 20, expandable portion 16 expands outwards in a second stage of expansion, which is a greater outwardly directed expansion than the first stage of expansion.

Anchoring system 10 preferably includes a wedging device adapted to wedge the wedge 18 against expandable portion 16. In one embodiment of the invention, the wedging device comprises a threaded portion 26 formed on wedge 18, which mates with a threaded portion 28 of shank 14. As seen in FIG. 1, an end 30 of wedge 18 may be provided with a male Allen screw head or a female Allen socket head or equivalent. An Allen wrench or key (not shown) may be used to rotate wedge 18 and thereby advance wedge 18 into expandable portion 16. It is to be emphasized that this is merely one example of a wedging device for moving wedge 18, and the skilled artisan will appreciate that many other kinds of wedging devices may be provided. For example, instead of advancing wedge 18 by means of screw threads, wedge 18 may be generally smooth and hammered into expandable portion 16 with a hammerset tool.

Shank 14 may comprise an internally threaded portion 36 adapted for threaded engagement with a male-threaded fastener (not shown). In such an embodiment, anchor 12 serves as a threaded insert that may be secured to a wall or ceiling for accepting the male-threaded fastener.

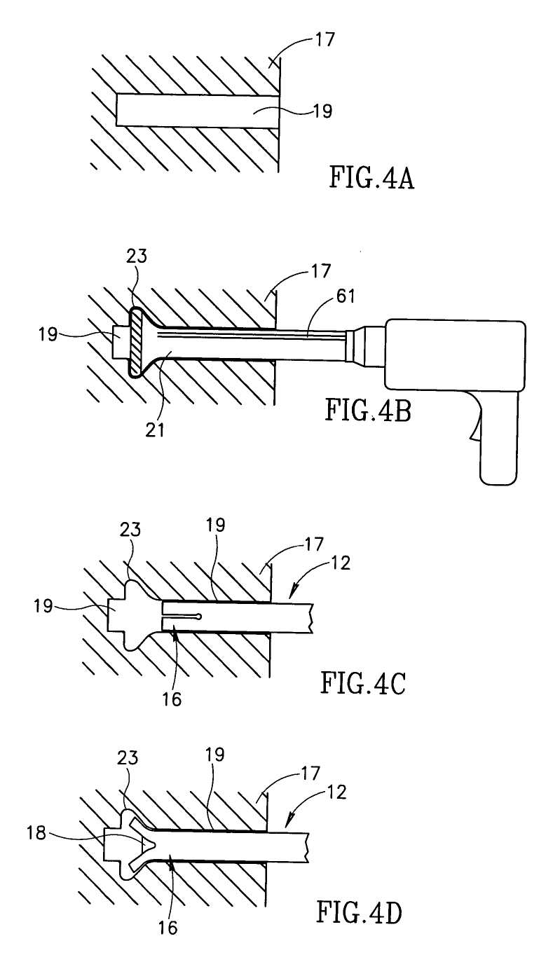

Reference is now made to FIGS. 2 and 3, which illustrate the expansion of expandable portion 16, and to FIGS. 4A-4D which illustrate the installation of anchor 12 and the use of anchoring system 10.

To install anchor 12 in a wall 17, a straight hole 19 may be drilled in wall 17 (FIG. 4A). In accordance with a preferred embodiment of the present invention, an undercut drilling tool 21 may be used to drill an undercut portion 23 in wall 17 (FIG. 4B). Undercut drilling tool is preferably constructed as described in U.S. Pat. No. 6,213,859 to Yekutiely et al., the disclosure of which is incorporated herein by reference. As seen in FIG. 4B, the undercut drilling tool may be provided with a passageway 61 for blowing air therethrough so as to clean the drilled hole from debris. For example, a pneumatic drill may be used to drill the holes, and some of the pressurized air used to power the pneumatic drill may be bled, bypassed or otherwise diverted through passageway 61 to clean the drilled hole from debris. (Alternatively, the drill may be electrically powered, and the cleaning air may be supplied from a separate air source.) This makes the drilling and cleaning process a one-step process, wherein the hole is drilled and generally simultaneously cleaned in one step. Anchor 12 may then be inserted in hole 19, and wedge 18 may be wedged against expandable portion 16 by wedging device 26.

Referring to FIG. 2 and FIG. 4C, wedge 18 may be moved by the wedging device to wedge against the second portion 22 (e.g., screwing wedge 18 into expandable portion 16, as described above), wherein expandable portion 16 expands outwards in the first stage of expansion. In the first stage of expansion, expandable portion 16 may expand against the inner diameter of straight hole 19 in a manner similar to prior art anchors.

However, unlike prior art anchors, wedge 18 may be moved by the wedging device to wedge against the first portion 20, as seen in FIG. 3 and FIG. 4D, wherein expandable portion 16 expands outwards in the second stage of expansion. In the second stage, expandable portion 16 expands without resistance into the cavity of undercut portion 23. Once expanded in undercut portion 23, expanded portion 16 tightly and reliably locks anchor 12 in place. The undercut portion 23 has a significantly greater area against which expanded portion 16 presses than straight hole 19, and thus the holding strength of anchor 12 is significantly greater than the prior art. At the same time, there is less stress on the building material of wall 17 because of the greater area over which anchor 12 exerts pressure. The result is that anchor 12 has significantly greater fastening integrity, reliability and longevity than prior art anchors.

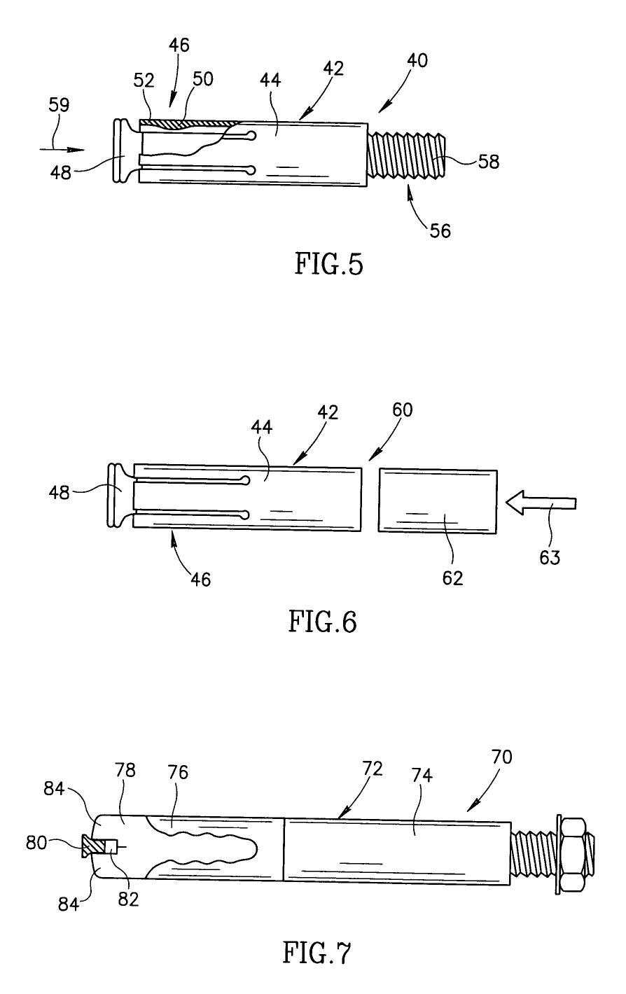

It is noted that in anchor 12, wedge 18 is moved generally distally in the direction of an arrow 39 (FIGS. 2 and 3) by wedging device 26. Reference is now made to FIG. 5, which illustrates an alternative construction of an anchoring system 40 in accordance with the present invention. In this embodiment, an anchor 42 comprises a shank 44 with an expandable portion 46 and a wedge 48 arranged to wedge against expandable portion 46. Wedge 48 is coupled to a wedging device 56, comprising a threaded rod 58, meaning that anchor 42 is a threaded anchor. Threaded rod 58 may alternatively comprise a bolt, meaning that anchor 42 is a bolt anchor. Expandable portion 46 has a first portion 50 thicker than a second portion 52 thereof. In this embodiment, wedge 48 is moved generally proximally in the direction of an arrow 59 by wedging device 56.

As described hereinabove for anchoring system 10, in anchoring system 40 expandable portion 46 is constructed as a variable-size fulcrum for wedge 48 to wedge against. When wedge 48 wedges against the second portion 52, expandable portion 46 expands outwards in a first stage of expansion. When wedge 48 wedges against the first portion 50, expandable portion 46 expands outwards in a second stage of expansion, which is a greater outwardly directed expansion than the first stage of expansion.

Reference is now made to FIG. 6, which illustrates another alternative construction of an anchoring system 60 in accordance with the present invention. Anchoring system 60 is basically the same as anchoring system 40, except that the wedging device is a hammerset tool 62, which may drive shank 44 generally linearly with respect to wedge 48, such as with a blow of a hammer (not shown) in the direction of an arrow 63, thereby wedging wedge 48 in expandable portion 46. It is appreciated that alternatively hammerset tool 62 may be constructed to drive wedge 48 generally linearly relative to shank 44 (e.g., as mentioned above with reference to FIG. 1).

The present invention also seeks to provide an expanding wedge anchor, as is now described with reference to FIG. 7.

FIG. 7 illustrates an anchoring system 70, constructed and operative in accordance with a preferred embodiment of the present invention. Anchoring system 70 includes an anchor 72 comprising a shank 74 with an expandable portion 76 (such as an expandable collar) and an expandable wedge 78 arranged to wedge against expandable portion 76. Expandable wedge 78 preferably includes a secondary wedge 80, which is received in a recess 82 formed in wedge 78. Expandable wedge 78 is preferably formed with a plurality of leaves 84 adapted to expand outwards when wedged against by secondary wedge 80.

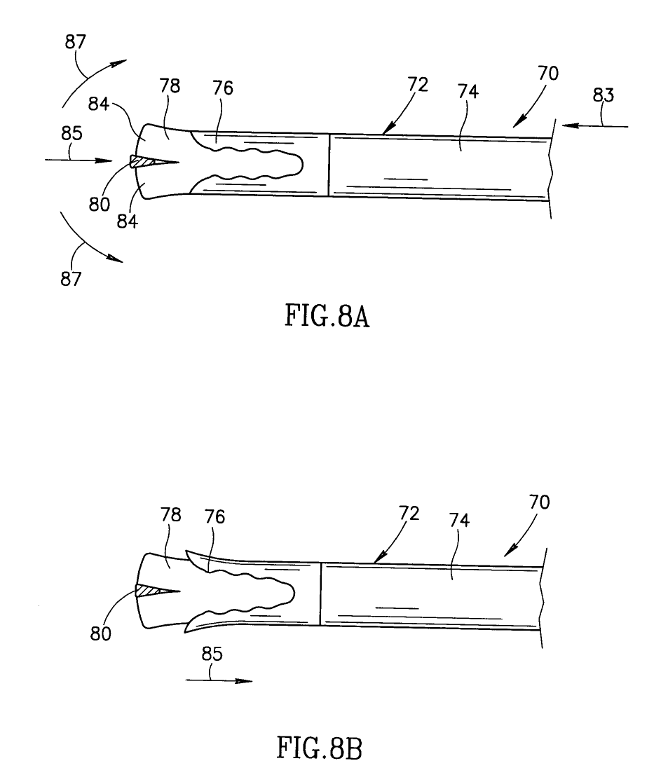

Reference is now made to FIGS. 8A and 8B, which illustrate expansion of anchoring system 70, in accordance with a preferred embodiment of the present invention.

After inserting anchor 72 in a hole in a wall (not shown), the anchor 72 may be struck, such as with a hammer or similar tool, in the direction of an arrow 83 so as to cause secondary wedge 80 to wedge into expandable wedge 78 in the direction of an arrow 85 (FIG. 8A). This cause leaves 84 of wedge 78 to expand outwards in the direction of arrows 87. The expansion of leaves 84 may itself be sufficient to fix anchor 72 in the hole. Wedge 78 may be pulled further (by a wedging device, as described hereinabove) in the direction of arrow 85, as seen in FIG. 8B, so as to wedge against expandable portion 76. Expandable portion 76 expands outwards because of wedge 78 pulled therein, and further fixes anchor 72 in the wall or ceiling.

It is appreciated that if the installation hole is an undercut hole, as described hereinabove with reference to FIGS. 4A and 4B, then the anchor strength and reliability will increase even more. It is appreciated that anchor 72 may be constructed like anchor 12 (FIG. 1) with a thicker first portion and thinner second portion, and wedge 78 may be moved by the wedging device to wedge either against the second portion or the first portion, thereby causing expandable portion 76 to expand in the undercut portion, as described hereinabove with reference to FIG. 4D.

Anchoring system 70 enables fixing anchor 72 either by just expanding wedge 78 or by further wedging the expandable wedge 78 against expandable portion 76. The extra expansion capability is a significant improvement over the prior art. For example, anchors with expansion collars are known that can be inserted in a hole drilled with the same diameter as the bolt used to fix the anchor in the drilled hole. However, such prior art anchors have limited expansion capability. In contrast to the prior art which has a non-expandable wedge, the expandable wedge 78 may be inserted in the same size drilled hole and yet provide significantly more expansion, and thereby significantly more strength and reliability, especially when installed in an undercut hole.

The present invention also seeks to provide a “dynamic” anchoring system that compensates for changes or weakening in the anchoring material, as is now described. The dynamic anchoring system may be incorporated in the anchoring systems described hereinabove as well.

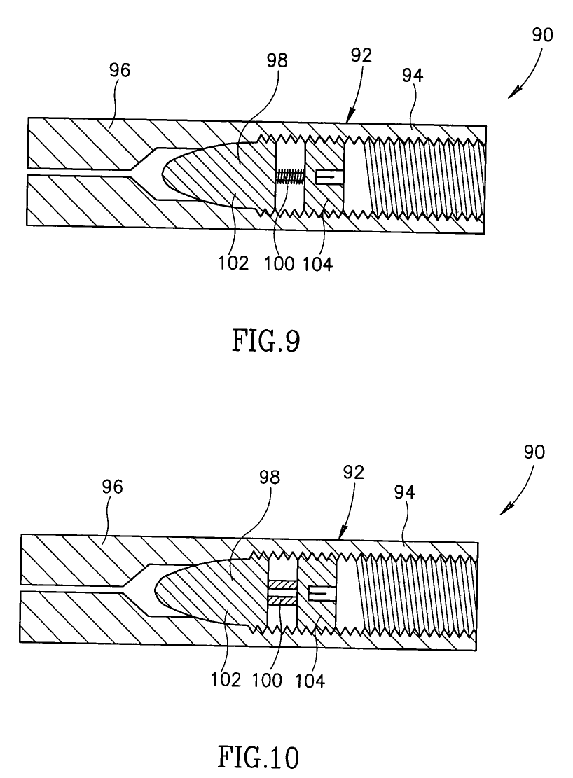

Reference is now made to FIG. 9, which illustrates an anchoring system 90, constructed and operative in accordance with a preferred embodiment of the present invention. Anchoring system 90 includes an anchor 92 comprising a shank 94 with an expandable portion 96 and a wedge 98 arranged to wedge against expandable portion 96.

As similarly described hereinabove for anchoring system 10, anchoring system 90 preferably includes a wedging device adapted to wedge the wedge 98 against expandable portion 96, such as a threaded connection between wedge 98 and shank 94. It is to be emphasized that this is merely one example of a wedging device for moving wedge 98, and the skilled artisan will appreciate that many other kinds of wedging devices may be provided. For example, instead of advancing wedge 98 by means of screw threads, wedge 98 may be generally smooth and hammered into expandable portion 96 with a hammerset tool.

A biasing device 100 is provided that is adapted to exert an outwardly directed expanding force against expandable portion 96. In the embodiment of FIG. 9, biasing device 100 comprises a coil spring placed between a distal portion 102 and a proximal portion 104 of wedge 98. Alternatively, as shown in FIG. 10, biasing device 100 may comprise an elastomeric material, with a high elasticity and spring constant. The skilled artisan will appreciate that these are just some examples of biasing devices, and other suitable biasing devices may be used to carry out the invention.

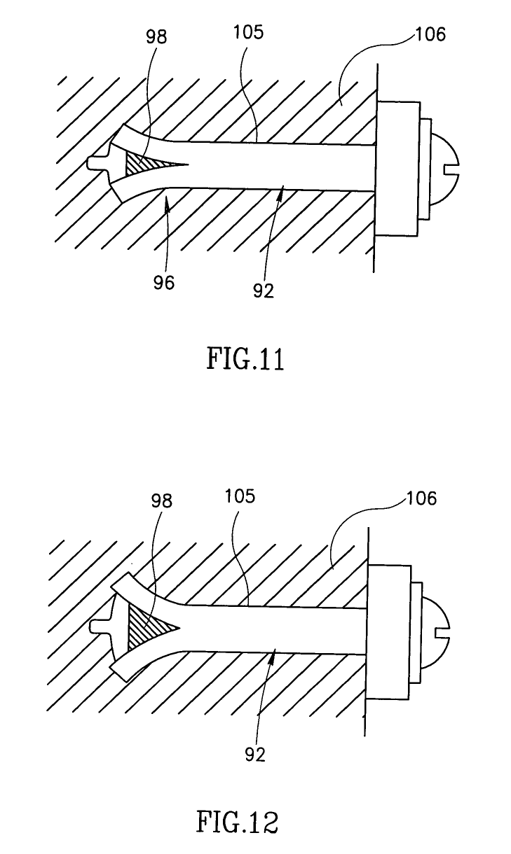

Reference is now made to FIG. 11, which illustrates anchor 92 installed in a hole 105 drilled in a wall 106. Wedge 98 wedges against expandable portion 96, thereby exerting a holding force against the inside surface of hole 105. Biasing device 100 applies a force generally in the direction of an arrow 107 (FIG. 9) to urge wedge 98 against expandable portion 96, thereby adding to the holding force against the inside surface of hole 105.

Reference is now made to FIG. 12, which illustrates the dynamic action of anchoring system 90. As seen in FIG. 12, the diameter of hole 105 has increased, such as over time due to vibration, or due to an earthquake, for example. In the prior art, such a situation would mean failure of the anchor. In contrast, in the present invention, despite the change in diameter or cracks in the vicinity of hole 105, biasing device 100 further expands expandable portion 96 and ensures that expandable portion 96 securely abuts against the inside surface of hole 105, thereby maintaining a secure fit of anchor 92 to wall 106.

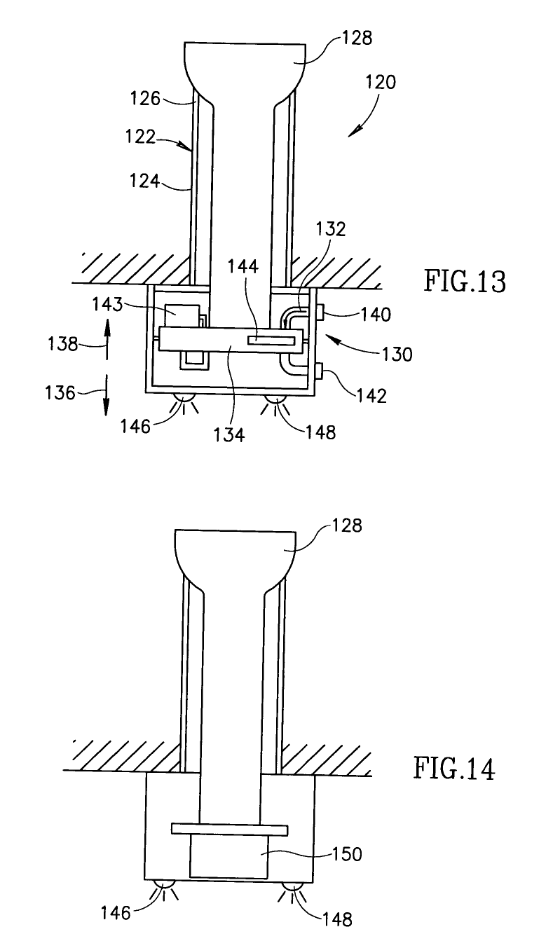

Another type of dynamic anchoring system with a power-driven biasing device, such as a fluid-power (hydraulic or pneumatic, for example) biasing device or electrical, electro-mechanical or electromagnetic biasing device (e.g., a solenoid or linear actuator, for example) is now described with reference to FIG. 13. This dynamic anchoring system may also be incorporated in the anchoring systems described hereinabove as well.

FIG. 13 illustrates an anchoring system 120, constructed and operative in accordance with a preferred embodiment of the present invention. Anchoring system 120 includes an anchor 122 comprising a shank 124 with an expandable portion 126 and a wedge 128 arranged to wedge against expandable portion 126. A power-driven biasing device, such as a fluid-power (hydraulic or pneumatic, for example) biasing device 130 is provided for wedging and biasing wedge 128 against expandable portion 126, so as to exert an outwardly directed expanding force against expandable portion 126. In the illustrated embodiment, fluid-power biasing device 130 comprises a hydraulic device with oil or water as the driving fluid, for example. However, it is appreciated that fluid-power biasing device 130 may alternatively comprise a pneumatic device with air as the driving fluid, for example.

Fluid-power biasing device 130 includes a driving fluid 132, such as oil or water, for example, which selectively applies fluid pressure against a piston 134 to which wedge 128 is secured. Pressure of driving fluid 132 in the direction of an arrow 136 causes wedge 128 to wedge against and expand expandable portion 126, thereby securing anchor 122 in a wall or ceiling, for example. Conversely, pressure of driving fluid 132 in the direction of an arrow 138, opposite to arrow 136, dislodges wedge 128 from expandable portion 126, thereby permitting removal of anchor 122 from the wall or ceiling, for example. Thus, biasing device 130 may selectively tighten and loosen anchor 122 into a wall or ceiling and the like.

It is appreciated that anchoring system 120 may be alternatively constructed so that wedge 128 becomes wedged in expandable portion 126 when moved in the direction of arrow 138 instead of arrow 136, for example.

Fluid-power biasing device 130 may include one or more inlet ports 140 for introduction of fluid 132, such as compressed air through an air nipple, and one or more exit ports 142 for exit or bleeding of fluid 132. Alternatively, fluid-power biasing device 130 may include a closed system, wherein driving fluid 132 remains sealed in device 130 and is pumped internally by a pump 143.

Anchoring system 120 may have safety/failure indicators to indicate if anchor 122 is safely anchored in place. For example, fluid-power biasing device 130 may include a pressure sensor or load cell 144, such as being mounted in or on piston 134, for example. Pressure sensor 144 may measure and monitor the pressure applied to piston 134 and wedge 128. When tightening anchor 122 in place, pressure sensor 144 may sense when the requisite pressure has been attained, and cause an indicator light 146 to light. Conversely, if the requisite pressure has not yet been reached or has diminished with time after proper installation, pressure sensor 144 may sense the inadequate pressure and cause an indicator light 148 to light. Pressure sensor 144 may cooperate with pump 143 in a closed system, wherein if the anchoring strength has changed due to vibration or catastrophe, the pressure exerted by biasing device 130 may be automatically increased to compensate for the lack of holding strength, and re-establish a safe strength. (It is appreciated that other indicators than lights 146 and 148 may be used, such as color-change indicators, for example.) Reference is now made to FIG. 14, which illustrates another version of a power-driven biasing device. In this embodiment, the power-driven biasing device comprises an electrical, electro-mechanical or electromagnetic biasing device 150, such as a solenoid or linear actuator, for example. The operation of biasing device 150 is basically the same as that of biasing device 130.

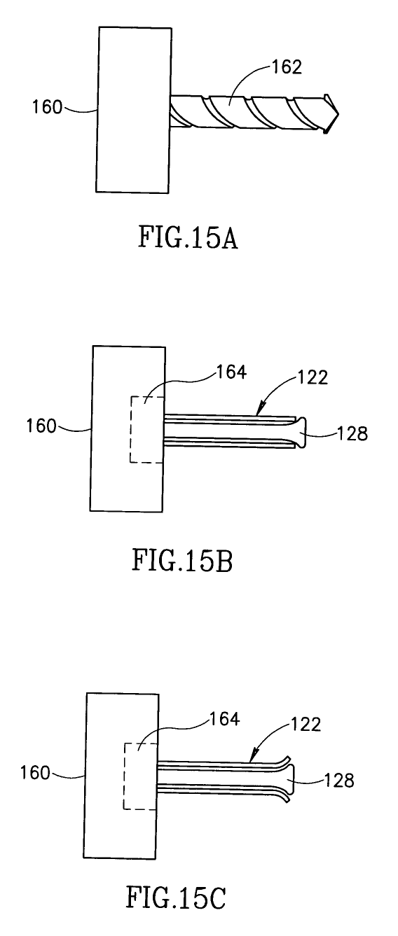

Anchoring system 120 may be used in a variety of systems. For example, reference is now made to FIGS. 15A, 15B and 15C, which illustrate apparatus 160 that incorporates therein anchoring system 120. Apparatus 160 may include a drill 162 (FIG. 15A) that may drill holes (and undercut holes) in a wall or ceiling and the like. Apparatus 160 may further include apparatus 164 (such as an actuator, motor or equivalent device) for inserting anchor 122 of anchoring system 120 (FIG. 15B) and selectively expanding or contracting anchor 122 (FIG. 15C), as described hereinabove with reference to FIG. 13 or FIG. 14. Apparatus 160 may be a type of hydraulic plate (or any other kind of power plate, such as a pneumatic plate) that can be used in a variety of applications.

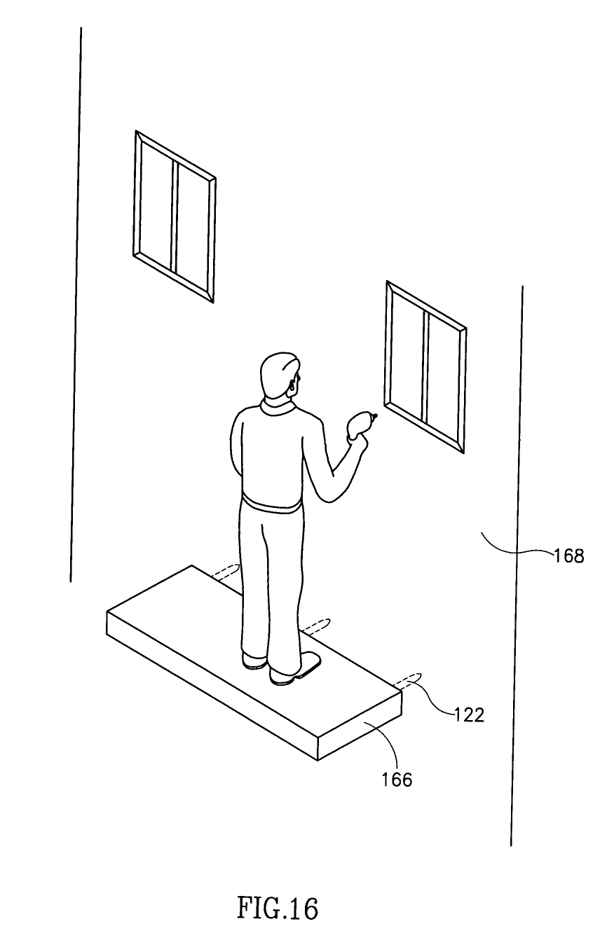

Reference is now made to FIG. 16, which illustrates one such application. In the embodiment of FIG. 16, apparatus 160 comprises a support platform 166 that is capable of climbing up a wall by drilling holes (with drill 162) and alternatively anchoring itself into a wall of a building 168 (by inserting anchor 122 into the drilled hole and expanding expandable portion 126) and releasing itself from the wall (by contracting expandable portion 126). It is appreciated that this is just one example of apparatus that incorporates anchoring system 120, and many other applications are within the scope of the invention.

It will be appreciated by person skilled in the art that the present invention is not limited by what has been particularly shown and described herein above. Rather the scope of the present invention is defined only by the claims that follow:

What is claimed is:

1. An anchoring system comprising:
an anchor comprising a shank with an expandable portion and a wedge arranged to wedge against said expandable portion, said expandable portion having a first portion thicker than a second portion thereof.

2. An anchoring system comprising:
an anchor comprising a shank with an expandable portion having a variable-size fulcrum and a wedge arranged to wedge against said variable-size fulcrum of said expandable portion.

3. The anchoring system according to claim 1 wherein said wedge is adapted to expand said expandable portion outwards further when wedged against said first portion than when wedged against said second portion.

4. The anchoring system according to claim 2 wherein said fulcrum comprises a first portion thicker than a second portion thereof, and said wedge is adapted to expand said expandable portion outwards further when wedged against said first portion than when wedged against said second portion.

6. The anchoring system according to claim 1 wherein said expandable portion is formed with a hole therethrough, said hole having a non-uniform diameter along its axial length, wherein a diameter of said hole is smaller at the first portion of said expandable portion than at the second portion of said expandable portion.

7. The anchoring system according to claim 1 and further comprising a wedging device adapted to wedge said wedge against said expandable portion.

8. The anchoring system according to claim 7 wherein said wedging device comprises a threaded connection between said wedge and said shank.

9. The anchoring system according to claim 7 wherein said wedging device comprises a hammerset wedging device adapted to impart relative axial motion between said wedge and said expandable portion.

10. The anchoring system according to claim 1 wherein said shank comprises an internally threaded portion adapted for threaded engagement with a male-threaded fastener.

11. The anchoring system according to claim 1 and further comprising an undercut drilling tool adapted to drill a hole with an undercut portion adapted for at least one of said first and second portions of said expandable portion to expand therein.

12. The anchoring system according to claim 1 and further comprising a biasing device adapted to exert an outwardly directed expanding force against said expandable portion.

13. The anchoring system according to claim 12 wherein said biasing device is adapted to urge said wedge against said expandable portion when said wedge is wedged against said expandable portion.

14. An anchoring system comprising:
an anchor comprising a shank with an expandable portion and an expandable wedge arranged to wedge against said expandable portion.

15. The anchoring system according to claim 14 wherein said expandable wedge comprises a secondary wedge which is received in a recess formed in said wedge, said secondary wedge, when wedged into said recess, being adapted to expand said expandable wedge outwards.

16. The anchoring system according to claim 15 wherein said expandable wedge is formed with a plurality of leaves adapted to expand outwards when wedged against by said secondary wedge.

17. The anchoring system according to claim 14 wherein said expandable portion has a first portion thicker than a second portion thereof.

18. The anchoring system according to claim 14 wherein said expandable portion has a variable-size fulcrum and said wedge is arranged to wedge against said variable-size fulcrum of said expandable portion.

19. The anchoring system according to claim 14 and further comprising a biasing device adapted to exert an outwardly directed expanding force against said expandable portion.

20. The anchoring system according to claim 17 wherein said biasing device is adapted to urge said wedge against said expandable portion when said wedge is wedged against said expandable portion.

21. An anchoring system comprising:
an anchor comprising a shank with an expandable portion and a wedge arranged to wedge against said expandable portion; and
a biasing device adapted to exert an outwardly directed expanding force against said expandable portion.

22. The anchoring system according to claim 21 wherein said biasing device is adapted to urge said wedge against said expandable portion when said wedge wedges against said expandable portion.

23. The anchoring system according to claim 21 wherein said biasing device comprises at least one of a spring and an elastomeric material.

24. The anchoring system according to claim 21 wherein said biasing device is power-driven.

25. The anchoring system according to claim 24 wherein said biasing device is driven by at least one of fluid, electrical, electro-mechanical and electromagnetic power.

26. The anchoring system according to claim 24 wherein said biasing device is adapted to selectively expand and contract said expandable portion.

27. The anchoring system according to claim 24 wherein said biasing device comprises a fluid-power biasing device that comprises a driving fluid that flows inside said biasing device and a pump adapted to pump said fluid.

28. The anchoring system according to claim 24 wherein said biasing device comprises an indicator adapted to indicate if said anchor is safely anchored in place.

29. The anchoring system according to claim 28 wherein said indicator comprises a pressure sensor adapted to sense a pressure applied to said wedge.

30. The anchoring system according to claim 29 wherein said biasing device comprises a fluid-power biasing device that comprises a driving fluid that flows inside said biasing device and a pump adapted to pump said fluid, and said pressure sensor cooperates with said pump in a closed system to control pressure exerted by said biasing device.

31. The anchoring system according to claim 24 and further comprising apparatus adapted to drill at least one hole, insert said anchor in said at least one hole, and selectively expand and contract said expandable portion of said anchor in said at least one hole.

32. A method for drilling a hole, comprising:
drilling a hole adapted to receive an anchor therein, and generally simultaneously blowing air into said hole so as to clean said hole from debris.

33. The method according to claim 32 wherein said drilling comprises drilling with a drill tool provided with a passageway for blowing air therethrough.

34. The method according to claim 33 wherein said drilling comprises drilling with a pneumatic drill powered by pressurized air, and diverting some of the pressurized air through said passageway.

35. The method according to claim 32 wherein said drilling comprises drilling an undercut hole.
